(19) United States
(12) Patent Application Publication
(10) Pub. No.: US 2011/0181170 A1
(43) Pub. Date: Jul. 28, 2011

(54) Field emission lamp

(75) Inventors: Hidenori Gamo, Tokyo (JP); Atsushi Namba, Tokyo (JP); Toshiya Arakawa, Tokyo (JP)

(73) Assignees: Toppan Printing Co., Ltd., Tokyo (JP); Fuji Jukogyo Kabushiki Kaisha, Tokyo (JP)

(21) Appl. No.: 13/064,506

(22) Filed: Mar. 29, 2011

Related U.S. Application Data
(63) Continuation of application No. PCT/JP2009/067060, filed on Sep. 30, 2009.

(30) Foreign Application Priority Data
Sep. 30, 2008 (JP) 2008-254757

(51) Int. Cl. H01J 1/02

(52) U.S. Cl. 313/309

(57) ABSTRACT

A field emission lamp which comprises a vacuum container, and a cathode electrode, a gate electrode and anode electrode all arranged in the vacuum container. The field emission lamp is characterized in that the cathode electrode is composed of a nanocarbon composite substrate which contains a substrate having a projected portion or grooved portion in a surface, and a nanocarbon material formed on the surface of the projected portion or grooved portion of the substrate.

### CROSS REFERENCE TO RELATED APPLICATIONS

This is a Continuation Application of PCT Application No. PCT/JP2009/067060, filed Sep. 30, 2009, which was published under PCT Article 21(2) in Japanese.

This application is based upon and claims the benefit of priority from prior Japanese Patent Application No. 2008-254757, filed Sep. 30, 2008, the entire contents of which are incorporated herein by reference.

### BACKGROUND OF THE INVENTION

1. Field of the Invention

This invention relates to a field emission lamp which is designed to realize the emission of light through excitation of a fluorescent substance by electrons that have been field-emitted from a cold cathode electron-emitting source.

2. Description of the Related Art

In recent years, a field-emission-type light-emitting device has been developed as a lamp which is high in luminance and low in power consumption. In this lamp, the emission of light is achieved through excitation of a fluorescent substance which occurs by impingement of the electrons field-emitted from a cold cathode electron-emitting source against a fluorescent substance in vacuum. The light-emitting devices of this kind are expected to be useful as a field emission lamp (FEL) or a field emission display (FED).

For example, JP-A 11-167886 discloses a field electron-emitting type display tube wherein a carbon nanotube is employed as the cathode electrode material. This display tube is constructed such that a housing equipped with a cathode electrode and a mesh portion (electron-extracting electrode), to which a voltage is impressed through each lead pin, and an anode electrode are disposed in a cylindrical glass bulb (an envelope) in the mentioned order on the bottom thereof. The cathode electrode is constructed such that a conductive plate is disposed on a ceramic substrate and a carbon nanotube is grown as an emitter on the surface of the conductive plate. The anode electrode includes a ring portion and a cylindrical portion. A face glass having a convex lens-like spherical portion is fixed to the front surface of the distal end of the glass bulb. A fluorescent screen formed on the inner surface of the face glass and an Al metal back film is laminated on the surface of the fluorescent screen. This Al metal back film is electrically connected, through a contact segment, with the cylindrical portion of the anode electrode.

This display tube is designed to emit light as described below. An electric field is applied between the cathode electrode and the housing, thereby enabling a high electric field to concentrate at the distal end of the carbon nanotube. As a result, electrons are extracted and emitted from the mesh portion of the housing. Meanwhile, a high voltage is applied to the anode electrode and to the Al metal back film, thereby enabling the emitted electrons to accelerate at the cylindrical portion of anode electrode. As a result, electrons are enabled to pass through the Al metal back film and to impinge against the fluorescent screen. As a result, the fluorescent substance constituting the fluorescent screen is excited because of this electron impingement, thereby enabling a desired color emission in conformity with the kinds of the fluorescent substance. The light thus emitted is enabled to pass through the face glass to display an image on the front surface thereof.

Because of the employment of carbon nanotube as the cathode electrode as described above, it is possible to obtain a field emission lamp which is stable for a long period of time and high in reliability.

In the case of the conventional field emission lamps, an emitter made of carbon nanotube is formed on the surface of a planar substrate (a conductive plate). Each tube of the carbon nanotube exhibits a very high aspect ratio. However, when an ordinary known method such as a screen printing method or a chemical vapor deposition method is employed, the carbon nanotube is caused to be deposited densely on the substrate. Because of this, even if the carbon nanotube deposited is orientated perpendicular to the substrate, it is difficult to enable the electric field to concentrate. As a result, it is required to employ a high voltage in order to achieve the emission of electrons, thus inviting an increase of operating voltage.

### BRIEF SUMMARY OF THE INVENTION

### Problems to be Solved by the Invention

It is an object of the present invention to provide a field emission lamp which makes it possible to achieve emission of electrons at a lower voltage, to reduce the operating cost and to increase the useful life.

### Means for solving the problems

According to one aspect of the present invention, there is provided a field emission lamp which comprises a vacuum container; and a cathode electrode, a gate electrode and anode electrode all arranged in the vacuum container, wherein the cathode electrode is composed of a nanocarbon composite substrate which contains a substrate having a projected portion or grooved portion in a surface, and a nanocarbon material formed on the surface of the projected portion or grooved portion of the substrate.

### Effects of the Invention

According to the field emission lamp of the present invention, since the substrate of the cathode electrode has a surface with a projected portion or grooved portion exhibiting a high aspect ratio, the concentration of electric field can be facilitated, the emission of electrons can be achieved at a lower voltage, the operating cost can be reduced and the useful life can be elongated.

### BRIEF DESCRIPTION OF THE SEVERAL VIEWS OF THE DRAWING

FIG. 1 is a cross-sectional view of a field emission lamp according to one embodiment of the present invention;

FIG. 2A is a cross-sectional view of a nanocarbon composite substrate constituting the cathode electrode of a field emission lamp according to another embodiment of the present invention, wherein the carbon material is grown at random on the surface of the substrate;

FIG. 2B is a cross-sectional view of a nanocarbon composite substrate constituting the cathode electrode of a field emission lamp according to another embodiment of the present invention, wherein the carbon material is grown perpendicular to the surface of the substrate;

FIG. 3 is a perspective view of a projected portion having various configurations and a cross-sectional view of a grooved portion, both being formed on the surface of a nanocarbon composite substrate constituting the cathode electrode of a field emission lamp according to another embodiment of the present invention;

FIG. 4A is a scanning electron microscopic image of the nanocarbon composite substrate having a prismatic projected portion and manufactured in another example of the present invention; and

FIG. 4B is a scanning electron microscopic image of the nanocarbon composite substrate having a pyramidal projected portion and manufactured in another example of the present invention.

### DETAILED DESCRIPTION OF THE INVENTION

There will now be described specific embodiments of the present invention with reference to drawings.

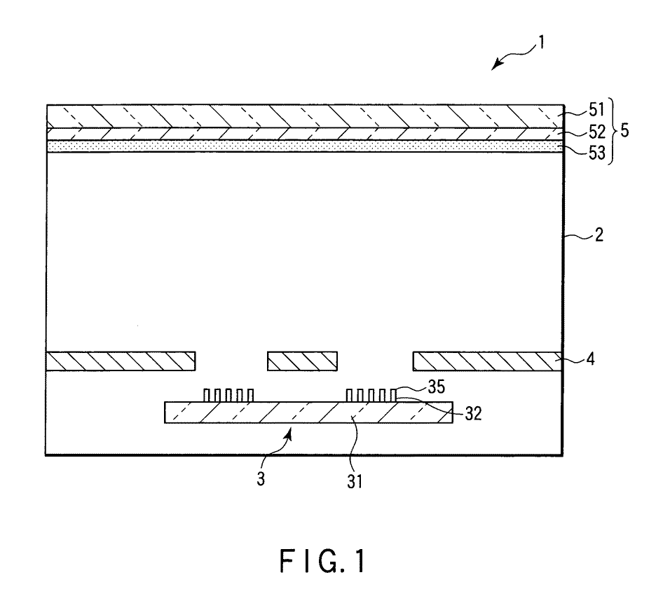

FIG. 1 shows a cross-sectional view of a field emission lamp according to one embodiment of the present invention. The field emission lamp 1 shown in FIG. 1 is constructed such that a cathode electrode 3, a gate electrode 4 and an anode electrode 5 are disposed parallel to each other in a vacuum container 2. The cathode electrode 3 comprises a nanocarbon composite substrate including a substrate having a projected portion and grooved portion formed thereon, and nanocarbon material (emitter) 35 deposited on the surface of the projected portion or grooved portion of the substrate. The construction of the cathode electrode 3 will be explained in detail hereinafter.

The gate electrode 4 is formed of a metal plate having openings each positioned in conformity with the emitter of the cathode electrode 3 and having a predetermined diameter. The anode electrode 5 is constituted by a transparent conductive film 52 to be used as an electrode and by an electron beam-exciting fluorescent substance 53, both of which are laminated on the both surfaces of a glass substrate 51. In a case where a high-velocity electron beam of about 10 kV or more is to be used, the fluorescent substance may be directly deposited on the glass substrate 51 and an Al metal back may be deposited on the surface of the fluorescent substance.

The space between the cathode electrode 3 and the gate electrode 4 may preferably be confined to 0.5-2 mm in order to prevent electric discharge and to facilitate the concentration of electric field. Further, the space between the gate electrode 4 and the anode electrode 5 may preferably be not less than 5 mm in view of preventing the reflection of ions.

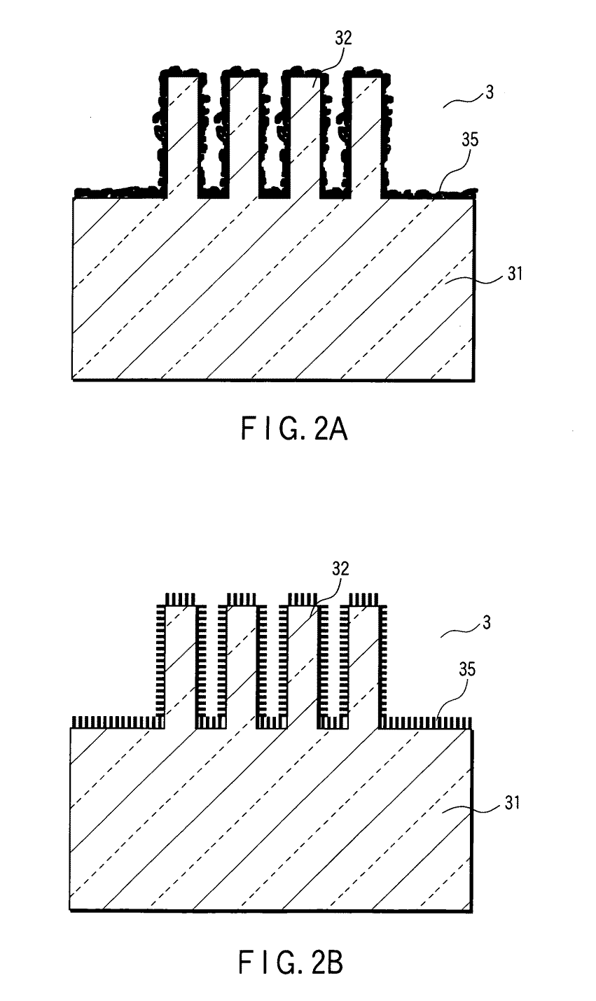

One example of the nanocarbon composite substrate constituting the cathode electrode 3 will be explained with reference to FIGS. 2A and 2B. In the case of the cathode electrode 3 shown in FIG. 2A, projected portion 32 is formed on the surface of a substrate 31 and a nanocarbon material 35 is grown on the surface of the substrate 31 including the top faces and sidewalls of the projected portion 32. In this FIG. 2A, the nanocarbon material 35 is orientated at random. Whereas in the case of the cathode electrode 3 shown in FIG. 2B, the growth of the nanocarbon material 35 is orientated perpendicular to the surface of the substrate 31 including the top faces and sidewalls of the projected portion 32.

The nanocarbon material 35 can be formed as follows. Namely, a catalyst is deposited on the face of the projected portion 32 to obtain the projected portion 32 carrying the catalyst, on which the nanocarbon material is allowed to grow by means of a solid/liquid interface contact decomposition method. The composite substrates shown in FIGS. 2A and 2B can be produced by controlling the synthesis conditions thereof (for example, the quantity of catalyst to be carried on the surface and synthesis temperature) in the solid/liquid interface contact decomposition method. For example, when the quantity of catalyst to be carried on the surface is increased as compared with that required to form a nanocarbon material which is orientated perpendicular to the surface of the substrate as shown in FIG. 2B, the growth of the nanocarbon material 35 tends to become random showing no orientation as shown in FIG. 2A.

In the structure shown in FIG. 2A, since the portion where an electric field can be concentrated is an edge portion of a worked substrate and an electric field is concentrated at an edge portion of the structure, it is possible to realize effective concentration of electric field. On the other hand, in the structure shown in FIG. 2B, since the portion where an electric field can be concentrated is the nanocarbon material that has been grown and orientated at an edge portion of a worked substrate and an electric field is concentrated at an edge portion of a structure, especially at the projected portion of the orientated nanocarbon material, it is possible to realize more effective concentration of electric field.

As for the materials of the substrate 31, it is possible to employ a semiconductor material such as monocrystalline silicon, germanium, gallium arsenide, phosphorus gallium arsenide, gallium nitride, silicon carbide, etc.; glass; ceramics; quartz; etc. With respect to the thickness of the substrate 31, although there is not any particular limitation, it is generally preferable to confine it to 100-1500 μm.

With respect to the height of the projected portion 32, it is preferable to make it not less than 10 μm. As the aspect ratio of the projected portion 32 becomes larger, the concentration of electric field is liable to be facilitated correspondingly. Therefore, it is preferable to appropriately design the aspect ratio of projected portion 32. When the height of projected portion 32 is less than 10 μm, it would become difficult to sufficiently increase the aspect ratio of projected portion 32.

With regard to the material for the nanocarbon material 35, it is possible to employ carbon nanotube, carbon nanofiber, carbon nanohorn, carbon nanofilament, carbon nanowall or carbon nanocoil, each nanocarbon material having a diameter of the order of nanometers and being excellent in crystallinity. From the viewpoints of excellence in electrical conductivity and thermal conductivity and of improving the characteristics of device, the employment of the nanocarbon materials having a diameter of the order of nanometers and being excellent in crystallinity is preferable.

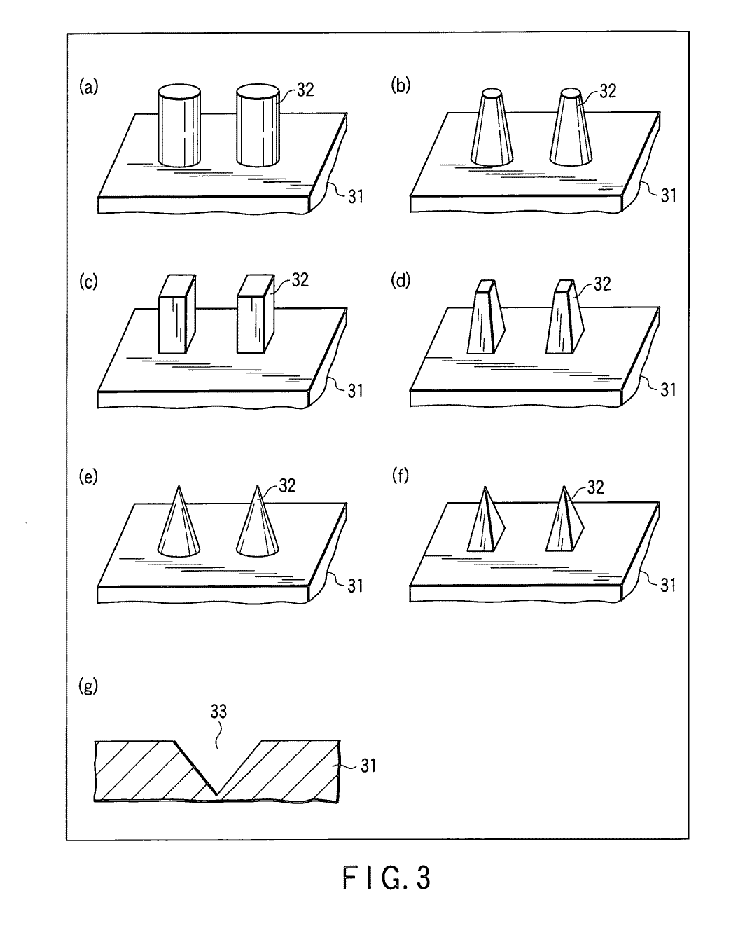

As shown in FIG. 3[(a)-(g)], the projected portion 32 or grooved portion 33 can be shaped into various configurations. The shapes of the projected portion 32 shown in FIG. 3[(a)-(f)] represent column (a), truncated cone (b), prism (c), truncated pyramid (d), cone (e) and pyramid (f), respectively. The configuration of the grooved portion 33 shown in FIG. 3(g) is V-shaped in cross-section. Although not shown, the configuration of the grooved portion 33 may be of any other kinds such as U-shaped in cross-section.

As shown in FIG. 3[(a)-3(d)], when the shape of the projected portion 2 is made into a trapezoidal configuration such as column, truncated cone, polygonal column and truncated pyramid, the control of characteristics of device can be more effectively facilitated.

When the shape of the projected portion is made into the shape of cone or polygonal pyramid having a sharp top as shown in FIG. 3[(e) or (f)], it is also possible to more effectively and easily control the characteristics of device.

Even if V-shaped grooved portion 33 are formed as shown in FIG. 3(g), it is also possible to facilitate the concentration of electric field and to operate the lamp at a lower voltage.

As described above, according to the field emission lamp according to one embodiment of the present invention, since a nanocarbon composite substrate which is constituted by a substrate having a projected portion or grooved portion and by a nanocarbon material deposited on the face of the projected portion or grooved portion at a high density is employed as the cathode electrode thereof, it is possible to facilitate the concentration of electric field on account of the physical features of the substrate, thereby making it possible to drive it at a lower voltage.

The nanocarbon composite substrate constituting the cathode electrode may preferably be manufactured by means of the aforementioned solid/liquid interface contact decomposition method. This method comprises forming a projected portion or grooved portion on a substrate; depositing a catalyst on the faces of the projected portion or grooved portion; and immersing and heating the substrate having the catalyst carried on the projected portion or grooved portion in an organic liquid to thereby allow a nanocarbon material to grow on the faces of the projected portion or grooved portion.

The employment of the aforementioned solid/liquid interface contact decomposition method is advantageous in that since the raw material is formed of an organic liquid, it is possible to enable the raw material to penetrate into very narrow portions of the projected portion 2 (or grooved portion), thereby making it possible to bring about a uniform chemical synthesis reaction. For this reason, it is possible to uniformly form a nanocarbon material which is high in purity and in crystallinity on the surface of the substrate having the projected portion (or grooved portion).

### Example

The following as an explanation of specific examples of the present invention.

By means of mechanical cutting work, a prismatic or pyramidal projected portion was formed on the surface of an n-type monocrystalline silicon (100) substrate having a low electrical resistance. The height of each of the projected portion was set to 100 μm.

Then, by means of magnetron sputtering method, cobalt as a catalyst was deposited on the surface of the mechanically worked silicon substrate. The quantity of cobalt that was deposited on the surface of substrate was set so as to correspond to 6 nm in film thickness.

The resultant substrate was immersed in methanol and electric current was passed through electrodes to the substrate so as to heat the substrate for three minutes at 600° C. at first and then to heat the substrate for 6 minutes at 900° C. As a result, a solid/liquid interface contact decomposition reaction using carbon atoms in the methanol as a raw material was caused to take place in the vicinity of the substrate, thereby forming carbon nanotube on the surface of the substrate. As a result, it was possible to enable the growth of carbon nanotube to orientate perpendicular to the top faces and sidewalls of the projected portion on the substrate.

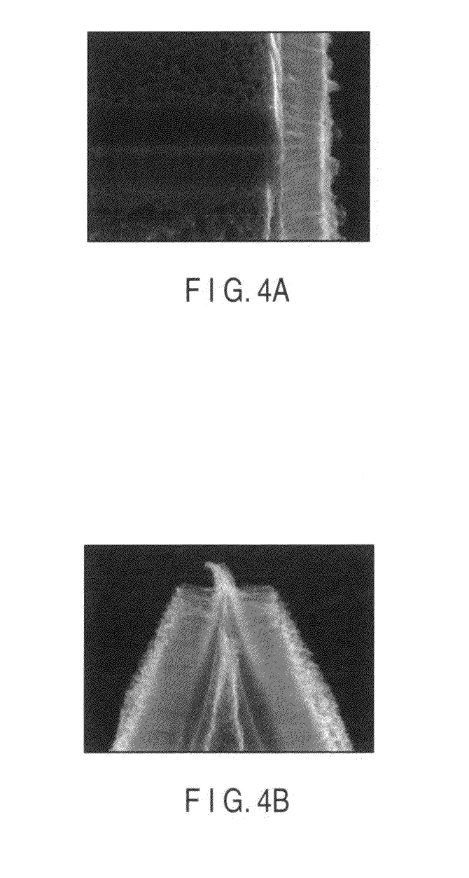

FIGS. 4A and 4B show respectively a scanning electron microscopic image of the nanocarbon composite substrate containing the carbon nanotube grown on the faces of the projected portion of substrate. FIG. 4A shows one example where the projected portion is respectively of a prism and FIG. 4B shows another example where the projected portion is respectively of a pyramid. In both examples, it was confirmed that carbon nanotube was grown at a high density and perpendicularly to the faces of the projected portion. The length of the carbon nanotube thus grown was about 2.5 μm.

Then, the nanocarbon composite substrate thus manufactured was employed as the cathode electrode 3, and the anode electrode 5 was disposed to oppose to the cathode electrode 3, with the gate electrode 4 interposed therebetween. The space between the cathode electrode 3 and the gate electrode 4 was set to 1 mm, and the space between the gate electrode and the anode electrode was set to 10 mm. When the electric field electron-emitting characteristics thereof in the vacuum container 2 was measured under these conditions, it was possible to confirm the emission of electrons at a gate voltage of as low as not more than 2.0 kV with the anode electrode voltage being set to 5 kV.

Since the field emission lamp of the present invention is low in energy, high in luminance, long in useful life and vary small in the generation of heat, it is expected to be useful in various fields taking the place of the conventional illumination. For example, it can be used, in addition to general illumination, in the cultivation of vegetables, as a lamp for surgical operations or as a car lamp, etc.

### EXPLANATION OF SYMBOLS

1 - - - Field emission lamp, 2 - - - Vacuum container, 3 - - - Cathode electrode, 4 - - - Gate electrode, 5 - - - Anode electrode, 31 - - - Substrate, 32 - - - Protruded portion, 33 - - - Grooved portion, 35 - - - Nanocarbon material, 51 - - - Glass substrate, 52 - - - Transparent electrode, 53 - - - Fluorescent substance.

What is claimed is:

1. A field emission lamp which comprises:
a vacuum container; and
a cathode electrode, a gate electrode and anode electrode all arranged in the vacuum container,
wherein the cathode electrode is composed of a nanocarbon composite substrate which contains a substrate having a projected portion or grooved portion in a surface, and a nanocarbon material formed on the surface of the projected portion or grooved portion of the substrate.

2. The field emission lamp according to claim 1, wherein the projected portion has a height of not lower than 10 μm.

3. The field emission lamp according to claim 1, wherein the nanocarbon material is at least one kind of material selected from the group consisting of carbon nanotube, carbon nanofiber, carbon nanohorn, carbon nanofilament, carbon nanowall and carbon nanocoil, and is orientated perpendicular to the surface of the projected portion or grooved portion.

4. The field emission lamp according to claim 1, wherein the projected portion is of a shape selected from the group consisting of column, truncated cone, polygonal column and truncated polygonal pyramid.

5. The field emission lamp according to claim 1, wherein the projected portion is of cone or pyramid.
